(19) United States
(12) Patent Application Publication
(10) Pub. No.: US 2003/0002844 A1
(43) Pub. Date: Jan. 2, 2003

(54) Optical power beam dump

(76) Inventors: Michael E. DeRosa, Painted Post, NY (US); William J. Miller, Horseheads, NY (US); Donald M. Trotter JR., Newfield, NY (US); Ljerka Ukrainczyk, Painted Post, NY (US); Debra L. Vastag, Elmira Heights, NY (US); Peter G. Wigley, Corning, NY (US)

Correspondence Address: CORNING INCORPORATED, SP-TI-3-1, CORNING, NY, 14831

(21) Appl. No.: 10/059,762

(22) Filed: Jan. 29, 2002

Related U.S. Application Data
(63) Continuation-in-part of application No. 09/892,077, filed on Jun. 26, 2001, now abandoned.
(60) Provisional application No. 60/309,347, filed on Aug. 1, 2001.

(51) Int. Cl. G02B 6/00

(52) U.S. Cl. 385/139

(57) ABSTRACT

A device for dissipating optical power from an optical component having a functional element includes a terminated fiber adapted to be coupled to the functional element so as to receive a light beam from the functional element and a dissipating element which absorbs the light beam from the terminated fiber, converts the absorbed light beam into thermal energy, and dissipates the thermal energy.

### CROSS-REFERENCE TO RELATED APPLICATIONs

This application is a continuation-in-part of U.S. patent application Ser. No. 09/892,077, entitled “Optical Fiber Terminator,” filed Jun. 26, 2001.

This application claims benefit of the filing date of U.S. Provisional Application Ser. No. 60/309,347, entitled “High Optical Power Fiber Termination for Optical Components,” filed Aug. 1, 2001.

### BACKGROUND OF INVENTION

1. Field of the Invention

The invention relates to a device and a method for removing excess optical power from a fiber-optic component.

2. Background Art

There is an increasing demand for fiber-optic components that can withstand high optical power. This trend is being set due to increased channel count and data rates in optically amplified transmission systems as well as the advent of Raman amplification systems. Power levels that are now being sent through fiber-optic components can be anywhere from 200 to 500 mW. In Raman systems, power in the 1400+ nm wavelength range are promising to be 500 to 1000 mW or even more. Fiber-optic components exposed to such high power levels risk the possibility of sustaining high-power optical damage.

The damage from high continuous-wave optical sources in fiber is due primarily to photo-thermal mechanisms. When materials within a component absorb a fraction of the radiation, the energy most often gets efficiently converted into heat. At very high powers, even small to moderate absorption can result in a significant temperature rise. The critical factor for the component designer becomes how to manage the localized heat buildup due to photo-thermal temperature rises in the component package. The heat buildup can be caused by any material in the package that absorbs light. The heat buildup can also be caused by insertion losses intentionally designed into the component or by unintentional intrinsic material losses or scattering to other parts of the package.

Some fiber-optic components, such as variable optical attenuators, are designed to cause a controlled amount of insertion loss. Some fiber-optic components, such as optical amplifiers, are characterized by some insertion loss that causes their output signal with respect to their input signal to be attenuated. The critical issue for these devices when used in high power environments is what happens to the power that has been attenuated. The power has to be discarded or diverted in a safe manner. Otherwise, significant damage to components or even safety hazards can occur if proper consideration is not given to how to dissipate the large amount of power that is being discarded.

### SUMMARY OF INVENTION

In one aspect, the invention relates to a device for dissipating optical power from an optical component having a functional element. The device comprises a terminated fiber adapted to be coupled to the functional element so as to receive a light beam from the functional element. The device further comprises a dissipating element which absorbs the light beam from the terminated fiber, converts the light beam into thermal energy, and dissipates the thermal energy.

In another aspect, the invention relates to an optical component which comprises a dissipation port and an optical power beam dump coupled to the dissipation port. The optical power beam dump comprises a terminated fiber which receives a light beam from the dissipation port and a dissipating element which absorbs the light beam from the terminated fiber, converts the absorbed light beam into thermal energy, and dissipates the thermal energy.

In another aspect, the invention relates to an optical component having a functional element. The optical component comprises a terminated fiber coupled to the functional element to receive a light beam from the functional element and an energy dissipating element which encloses the functional element. The energy dissipating element absorbs the light beam from the terminated fiber, converts the light beam into thermal energy, and dissipates the thermal energy.

In another aspect, the invention relates to a method for dissipating thermal energy from an optical component having a functional element which comprises diverting a light beam from the functional element to a terminated fiber, absorbing the light beam from the terminated fiber, converting the light beam into thermal energy, and dissipating the thermal energy at a location remote from the functional element.

Other features and advantages of the invention will be apparent from the following description and the appended claims.

### BRIEF DESCRIPTION OF DRAWINGS

FIG. 1 shows an optical power beam dump according to an embodiment of the invention coupled to a dissipation port of an optical component.

FIG. 2A is a cross-sectional view of the optical power beam dump of FIG. 1 in accordance with one embodiment of the invention.

FIG. 2B is a cross-sectional view of the optical power beam dump of FIG. 2A with the optical axes of the lensed fiber and optical fiber misaligned.

FIG. 3A is a cross-sectional view of a lensed fiber having a small radius of curvature attached to a terminated end of an optical fiber.

FIG. 3B is a cross-sectional view of a coreless fiber with a facet angle attached to a terminated end of an optical fiber.

FIG. 3C is a cross-sectional view of a ball-terminated fiber.

FIG. 3D is a cross-sectional view of an optical fiber having a terminated end cleaved at an angle.

FIGS. 4A-4D illustrate a method for forming a lensed fiber.

FIG. 5 is a graph of return loss versus lens thickness for a lensed fiber having a radius of curvature of 235 μm.

FIG. 6 shows an optical power beam dump according to an embodiment of the invention attached to an optical component.

FIG. 7 shows an optical component having an integrated optical power beam dump according to an embodiment of the invention.

FIG. 8 shows a variable optical attenuator incorporating an embodiment of the optical power beam dump of the invention.

FIG. 9 shows a narrow beam dump device incorporating an embodiment of the optical power beam dump of the invention.

### DETAILED DESCRIPTION

Embodiments of the invention provide a device and method for safely dissipating optical power from a fiber-optic component, such as a variable optical attenuator, an optical coupler, a thin film filter, etc. In general, the invention uses a high-power fiber termination as an optical power beam dump to protect the fiber-optic component against excess optical power, which would ultimately be converted to thermal energy. The high-power fiber termination has a low back-reflection and acts as an optical power beam dump by first diffusing the excess light at the end of a fiber. The diffused light is then absorbed by an energy dissipating element, which converts the light into heat and dissipates the heat. The optical power beam dump can be located remotely from the fiber-optic component so that the heat is dissipated at a location remote from the optical component.

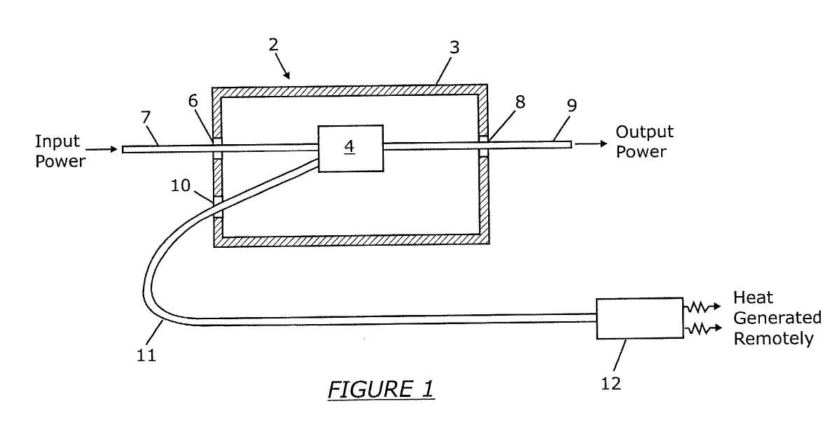

FIG. 1 shows an illustrative environment suitable for practicing the present invention. In particular, FIG. 1 shows an optical component 2 having a functional element 4, such as a thin film element, enclosed within a case 3. The functional element 4 performs an operation on light transported from an input port 6 to an output port 8. Light is transported to the functional element 4 through an input fiber 7 and transported out of the functional element 4 through an output fiber 9. The optical component 2 is provided with a dissipation port 10 through which excess optical power not transported to the output port 8 may be diverted away from the functional element 4. An optical power beam dump 12, according to an embodiment of the invention, is coupled to the dissipation port 10 by an optical fiber 11. The optical power beam dump 12 removes the excess optical power from the optical component 2 and converts it into thermal energy, which is dissipated at a location remote from the optical component 2. The optical power beam dump 12 has a low back-reflection, typically better than −55 dB.

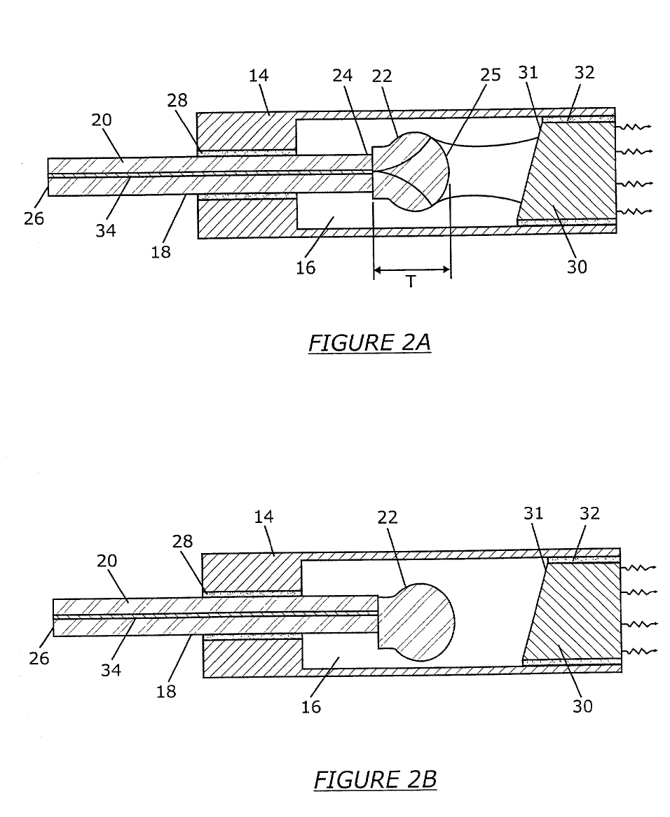

FIG. 2A shows a detailed view of one embodiment of the optical power beam dump 12. In the illustrated embodiment, the optical power beam dump 12 includes a ferrule 14 having a cavity 16. The ferrule 14 may be made of a glass material, such as SiO₂, B₂O₃—SiO₂, or GeO₂—SiO₂, or other material that can withstand high temperature or has low absorption at the wavelengths to be passed through the optical power beam dump 12. A terminated fiber 18 is inserted into one end of the cavity 16. Although not shown, one or both ends of the ferrule 14 may be tapered (or flared) to aid in inserting the terminated fiber 18 into the cavity 16. The terminated fiber 18 includes an optical fiber 20 and a lensed fiber 22. The optical fiber 20 may be a single-mode or a multimode fiber. The lensed fiber 22 is attached to an end 24 of the optical fiber 20, while the other end 26 of the optical fiber 20 extends out of the cavity 16. The end 26 may be coupled to a port of a fiber-optic component, such as the dissipation port 10 shown in FIG. 1. Methods for polishing the end 26 of the fiber 20 to mate with an optical fiber at a port of a fiber-optic component are well known.

In the embodiment illustrated in FIG. 2A, the lensed fiber 22 is a coreless fiber having a curved terminal end 25. The lensed fiber 22 is made of a lens material, such as SiO₂, B₂O₃—SiO₂, or GeO₂—SiO₂. Opposite the lensed fiber 22 is an energy dissipating element 30. The energy dissipating element 30 absorbs the optical power exiting the lensed fiber 22 and converts the optical power into thermal energy, which is then distributed over the entire mass of the energy dissipating element 30. In this manner, the thermal energy that would otherwise be generated within an optical component, such as optical component 2 in FIG. 1, can be safely dissipated at a location remote from the optical component. The optical fiber 20 and the energy dissipating element 30 may be secured to the ferrule 14 with high-temperature adhesives 28, 32. In operation, the high-temperature adhesives 28, 32 also provide strain relief for the ferrule 14 and fiber 20. To improve reliability of the optical power beam dump 12, the ferrule 14 may be collapsed at both ends to form a hermetically-sealed ferrule. Further, the cavity 16 may be drawn into vacuum.

In addition to absorbing optical power from the lensed fiber 22, the energy dissipating element 30 also shrouds the terminal end 25 of the lensed fiber 22 so that the light exiting the terminal end 25 does not stray out of the cavity 16. To accomplish this, the energy dissipating element 30 is preferably spaced a distance from the terminal end 25 of the lensed fiber 18. The energy dissipating element 30 may be made of metal, such as aluminum or copper, or other material having thermal conductivity greater than 0.1 W/m. ° C. The higher the thermal conductivity, the better the heat removal from the energy dissipating element 30. Fins (not shown) may be provided on the energy dissipating element 30 to increase the heat transfer from the surface of the energy dissipating element 30. In the illustrated embodiment, the surface 31 of the energy dissipating element 30, opposite the lensed fiber 22, is angled to avoid back-reflection. Other means of avoiding back-reflection may also be used, such as constructing the energy dissipating element 30 from a solid black body or sandblasting, or roughening, the surface 31 of the energy dissipating element 30.

The lensed fiber 22 is a transparent, non-absorbing medium with a refractive index close to that of the core 34 of the optical fiber 20. The lensed fiber 22 acts as a focusing lens in that the beam traveling through the lensed fiber 22 is focused into a spot upon exiting the curved terminal end 25. The larger the radius of curvature of the terminal end 25, the larger the spot size. In order to allow the lensed fiber 22 to act as a focusing lens, the following condition should hold:

T/R_{c}>n/(n+1)+Φ 1

where T is the thickness of the lensed fiber, R_{c}, is the radius of curvature of the terminal end of the lensed fiber, n is the refractive index of the lensed fiber material at the wavelength of interest, and Φ is phase shift due to diffraction of the small Gaussian beam.

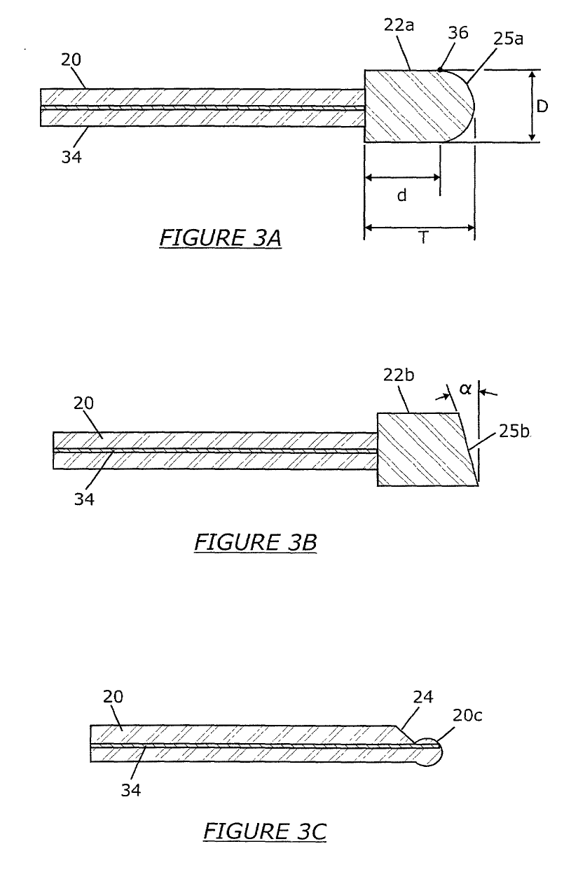

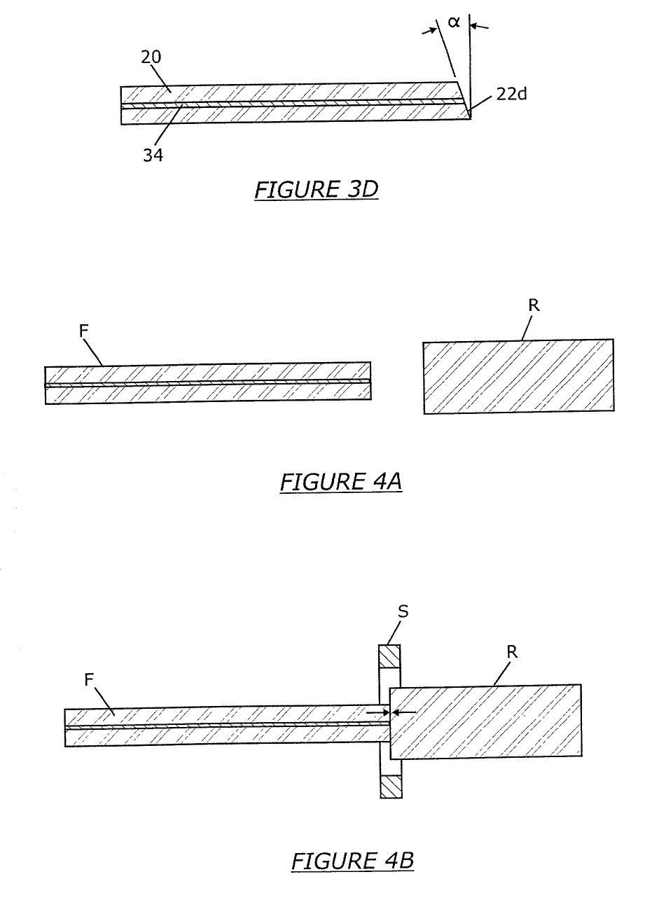

In the illustrated embodiment, the optical axis of the optical fiber 20 is aligned with the optical axis of the lensed fiber 22. To reduce back-reflection, the optical axis of the lensed fiber 22 may be offset from the optical axis of the optical fiber 20, as illustrated in FIG. 2B. Returning to FIG. 2A, the diameter of the lensed fiber 22 at the point of attachment to the optical fiber 20 is larger than the diameter of the optical fiber 20. In alternate embodiments, the diameter of the lensed fiber 22 may be made the same as or smaller than the diameter of the optical fiber 20 at the point of attachment to the optical fiber 20. Also, the terminal end 25 of the lensed fiber 22 is shown as having a large radius of curvature, e.g., greater than 60 μm. In alternate embodiments, the radius of curvature of the terminal end 25 may be made smaller, e.g., in a range from 25 μm to 60 μm. FIG. 3A shows a lensed fiber 22a having a terminal end 25a with a small radius of curvature. The appropriate thickness of the lensed fiber 22a can be determined using expression (1) above.

Other types of fiber terminations can be used instead of a lensed fiber (i.e., a coreless fiber terminated with a radius of curvature). For example, FIG. 3B shows a fiber termination that is a coreless fiber 22b terminated with a cleaved end 25b. The cleaved end 22b forms an angle α with respect to the vertical. Typically, the angle α is equal to or greater than 8°. In FIG. 3C, the fiber termination is a ball 22c formed at the end 24 the optical fiber 20. The ball 22c may be formed by applying heat to the end 24 of the optical fiber 20. Preferably, the optical axis of the ball 22c is offset from the optical axis of the optical fiber 20 to minimize back-reflection. In FIG. 3D, the fiber termination is an angled surface 22d formed at the end 24 of the optical fiber 20. The angled surface 22d is formed, for example, by cleaving the end 24 of the optical fiber 20. The angled surface 22d forms an angle α with respect to the vertical. Typically, the angle α is equal to or greater than 8°.

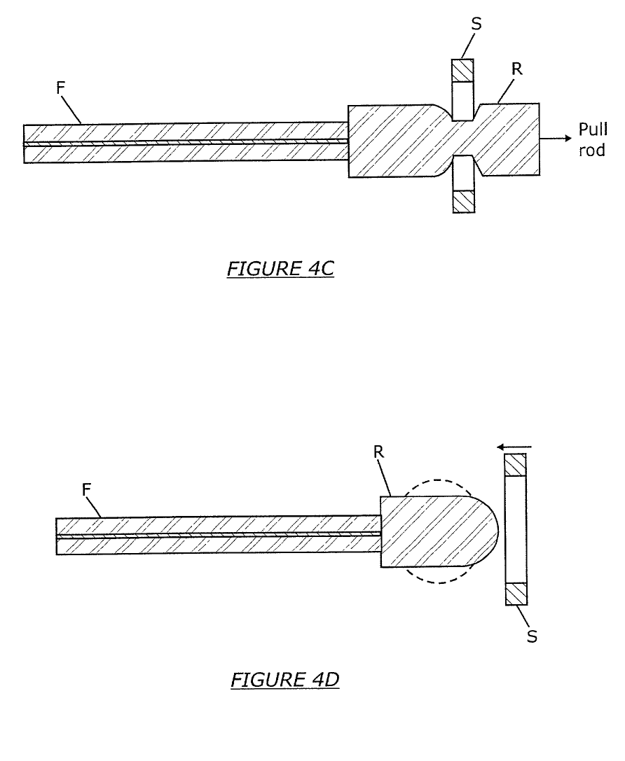

Returning to FIG. 2A, the fiber termination 22 (also the fiber terminations 22a in FIG. 3A and 22b in FIG. 3B) can be attached to the end 24 of the optical fiber 20 by processes such as fusion splicing, laser welding, or by an index-matched epoxy (or adhesive). The lensed fiber 22 having a large radius of curvature may be fabricated in four steps: aligning, fusion splicing, taper cutting, and melting back. For the lensed fiber (22a in FIG. 3A) having a small radius of curvature, the melting-back step may be omitted. As illustrated in FIG. 4A, the aligning step involves arranging an optical fiber F in opposing relation to a coreless fiber R. As illustrated in FIG. 4B, the fusion-splicing step involves fusing the opposing ends of the fiber F and coreless fiber R by heat from a heat source S. Typically, the heat source S is a tungsten filament loop. As illustrated in FIG. 4C, the taper-cutting step involves moving the heat source S along the coreless fiber R to taper-cut the coreless fiber R. While applying the heat, the coreless fiber R is pulled in a direction away from the fiber F to accomplish the taper cut. As illustrated in FIG. 4D, the melting-back step involves moving the heat source S toward the taper-cut end of the coreless fiber R to form the desired radius of curvature (indicated by the dotted line).

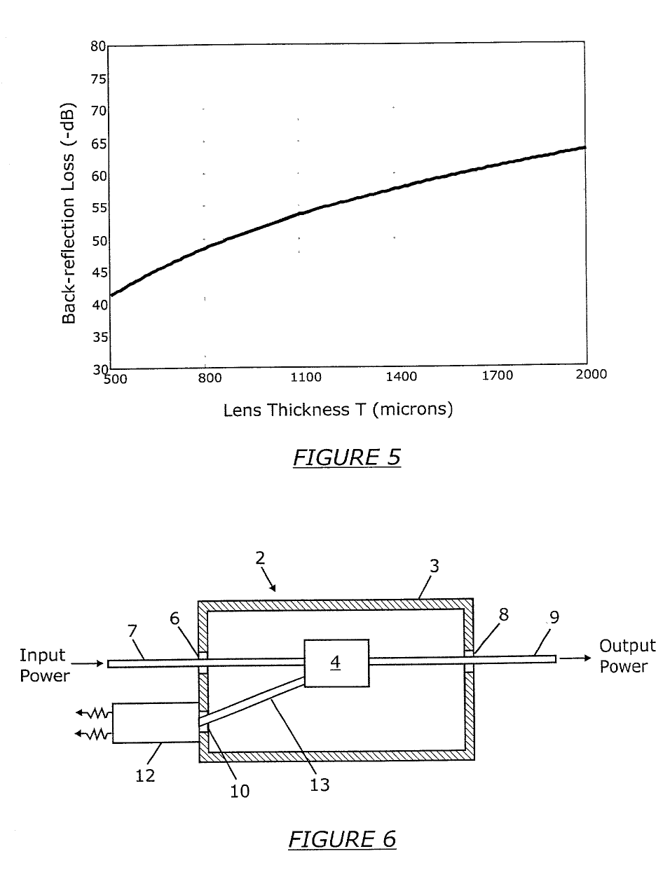

Returning to FIG. 2A, a beam transmitted through the fiber 20 exits the terminated end 24 and travels through the lensed fiber 22. As shown, the beam diverges as it travels through the lensed fiber 22 and is focused into a spot upon exiting the lensed fiber 22. The Fresnel reflection at the glass-air interface at the curved end 25 of the lensed fiber 22 depends on the geometry of the lensed fiber 22. FIG. 5 shows a graph of back-reflection loss as a function of the thickness of the lensed fiber. For the curve shown in FIG. 5, the Fresnel reflection at the glass-air interface at the curved end of the lensed fiber is 3.3%. According to the graph, for a lensed fiber having a radius of curvature of 235 μm and a length of approximately 1700 μm, the back-reflection loss is better than (or greater than) −55 dB. Using the standard definition of the term “db,” i.e., 10 ×log10(Pₒᵤₜ/Pᵢₙ), a back-reflection of −55 dB means that the amount of light reflected should be 10^{-5.5} as large as the power entering the lensed fiber. Preferably, the back-reflection is better than −50 dB.

Returning to FIG. 2A, the focal length of the curved surface 25 of the lensed fiber 22 is proportional to —R_{c}/2, where R_{c} is the radius of curvature of the curved surface 25. The preceding statement applies to any lensed fiber in general. Thus, the smaller the radius of curvature R_{c} of the curved surface 25, the shorter the focal length for the back-reflected beam. The shorter the focal length for the back-reflected beam, the more the reflected beam at the curved surface 25 will diverge, and the lower will be the back-reflection.

The length of the lensed fiber 22 is limited by the diameter of the lensed fiber 22 in such a way that the beam diameter at the point where the beam exits the lensed fiber 22 does not exceed the diameter of the lensed fiber 22. The preceding statement applies for any coreless fiber attached to the optical fiber 20, regardless of whether the coreless fiber is terminated with a radius of curvature or is cleaved at an angle. If the diameter of the beam exceeds that of the coreless fiber, waveguiding in the coreless fiber and resonance effects will occur.

In FIG. 3A, for example, if the optical fiber 20 is a single-mode fiber with 10-μm mode field diameter and the coreless fiber (or lens) 22a has a thickness (T) of 2 mm and a radius of curvature of 30 μm, the diameter of the coreless fiber 22a at a point 36 where the beam exits the coreless fiber 22a would need to be at least 300 μm to avoid waveguiding in the coreless fiber 22a and resonance effects. In general, the diameter (D) of a coreless fiber at a point where the beam exits the coreless fiber can be estimated as follows:

D≧2 ·w_{d} 2

where

W_{d} =dθ_{beam} 3

and

$${θ}_{beam} = \frac{λ}{π {w}_{o} n} \qquad 4$$

where w_{d} is the mode field radius at the point where the beam exits the lens, d is the length of the lens from the fiber-lens interface to the point where the beam exists the lens, θ_{beam} is angular spread of Gaussian beam outside Raleigh range, λ is wavelength of light, wₒ is mode field radius at the beam waist, and n is the refractive index at the wavelength of interest.

Returning to FIG. 1, the optical power beam dump 12 is shown as located remotely from the optical component 2. In an alternate embodiment, the optical power beam dump 12 may be mounted on the case 3, which encloses the functional element 4. FIG. 6 shows a scenario where the optical power beam dump 12 is mounted on a side of the case 3. An optical fiber 13 diverts the excess optical power from the functional element 4 to the optical power beam dump 12. The optical power beam dump 12 converts the excess optical power to heat, as previously described, and dissipates the heat at a location that is remote from the functional element 4.

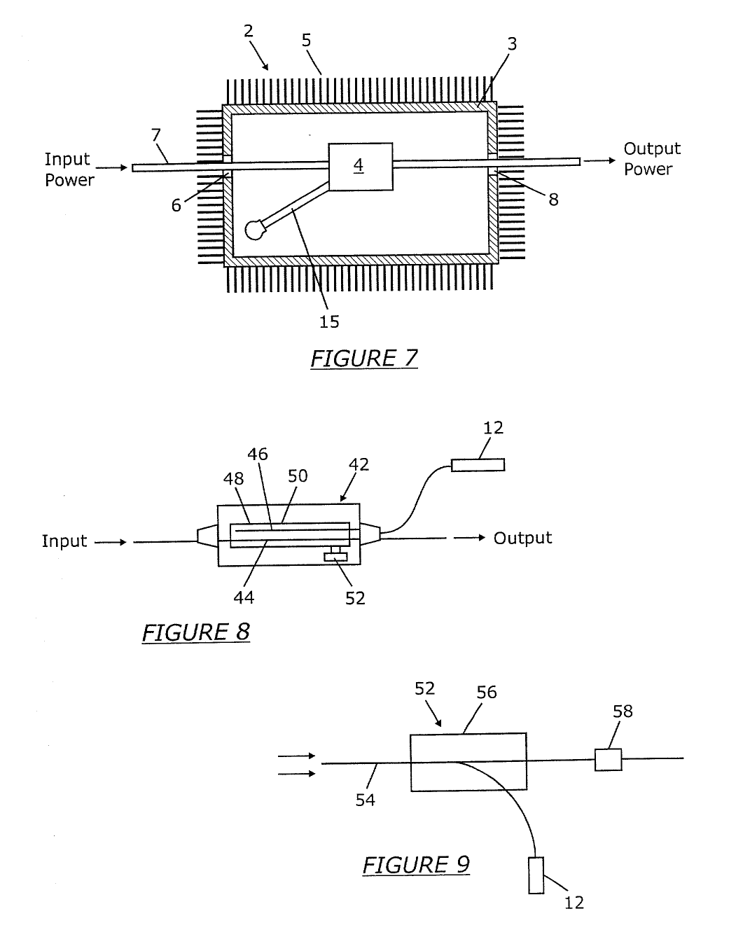

In another embodiment, the optical power beam dump may be integrated with the optical component 2. FIG. 7 shows a scenario where the optical power beam dump is integrated with the optical component 2. In this scenario, the case 3, which encloses the functional element 4, acts as the energy dissipating element. Fins 5 are provided on the case 3 to assist in dissipating heat from the optical component 2. A terminated fiber 15 is provided to divert excess optical power from the functional element 4 and diffuse the excess optical power away from the functional element 4.

The case 3, which acts as the energy dissipating element, absorbs the light exiting the terminated fiber 15 and dissipates the heat generated from the absorbed light. The terminated fiber 15 is shown as an optical fiber having a lensed end. However, any of the other types of terminated fibers described above can also be used.

The following are examples of applications where the optical power beam dump described above can be used. The examples presented below are for illustrative purposes only and are not intended to limit the invention in anyway. In general, the optical power beam dump is useful wherever there is a need to safely dispose of optical power.

One application of the optical power beam dump described above is in variable optical attenuators. FIG. 8 shows a schematic of a variable optical attenuator (VOA) 42. The VOA 42 functions by controlling the amount of optical power in a transmission fiber. The VOA 42 includes two optical fibers 44, 46 inserted into a glass capillary tube 48, which is heated and drawn down so that the fiber cores are very close together. When the coupled region 50 is straight, 100% of the light entering the VOA 42 stays in the optical fiber 44. However, when mechanical stress is applied to the coupler region 50 using a small motor 52, the coupler region 50 deforms, enabling a portion of the optical power from the optical fiber 44 to couple into the optical fiber 46. The more the coupler region 50 is deformed, the more light gets coupled into the optical fiber 46, and the higher the attenuation is in the optical fiber 44. In this type of VOA 42, the optical fiber 46 is usually very short and serves only as a conduit to dispose of the power.

What happens to the power coupled into the optical fiber 46 becomes a major concern when the VOA 42 is used in high power applications. When the attenuator level is set very high, most of the power transmitted to the VOA 42 is diverted to the optical fiber 46. The end of this fiber must be shielded in some way, or else two events could happen. First, eye or skin damage could occur to anyone in the vicinity of the VOA 42 that is not aware that power is emanating out of the optical fiber 46. Second, thermal damage could occur to anything that highly absorbs the wavelength of light coming out of the fiber 46. For example, this could be packaging material in the VOA package or some material in an amplifier package. It has even been reported that fires could be started due to the very high temperatures generated by the high fiber-optic power densities. In accordance with the invention, the optical power beam dump 12 can be coupled to the optical fiber 46 to safely dissipate power from the VOA 42, and thus prevent catastrophic events.

The optical power beam dump (12 in FIG. 2A) described above can also be used in a narrow band beam dump device. Unlike the VOA 42, which diverts or attenuates all wavelengths, a narrow band beam dump device will eliminate only a narrow portion of the spectrum or maybe even only a single wavelength. For example, a wavelength division multiplexer (WDM) can be used to strip off a single wavelength or a portion of the spectrum. When a WDM is used with the optical power beam dump of the present invention, the WDM can be used to protect other components downstream in the system.

FIG. 9 shows a module 52 having two wavelengths λ₁, λ₂ propagating down a fiber 54, which runs through a narrow band filter 56, such as a WDM. The first wavelength (λ₁) is low power, while the second wavelength (λ₂) is high power. If the component 58 downstream of the narrow band filter 56 has a high absorption at λ₂ and can be damaged by λ₂, then it would be useful to dispose of this harmful wavelength before it gets to the sensitive component. Additionally, since the harmful wavelength is of high power, it is best if the wavelength is diverted into the optical fiber beam dump 12, which will safely dispose of the optical power. By doing this, the sensitive component 58, which could be expensive, is protected, and the system is allowed to function normally.

The invention may provide one or more advantages. The optical power beam dump described above allows excess optical power that would otherwise produce high thermal energy in an optical component to be diverted to a location where it can be safely dissipated. This allows the optical component to be used in high power environments. The optical component can be provided with a dissipation port through which the excess optical power can be diverted away. The optical power beam dump also makes it possible to make smaller components because heat can be easily removed from the components.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A device for dissipating optical power from an optical component having a functional element, comprising:
a terminated fiber adapted to be coupled to the functional element so as to receive a light beam from the functional element; and
a dissipating element which absorbs the light beam from the terminated fiber, converts the absorbed light beam into thermal energy, and dissipates the thermal energy.

2. The device of claim 1, wherein the terminated fiber comprises a coreless fiber attached to a terminated end of an optical fiber, the coreless fiber being arranged in an opposing relation to the dissipating element.

3. The device of claim 2, wherein a diameter of the coreless fiber is larger than a diameter of the optical fiber.

4. The device of claim 2, wherein a diameter of the coreless fiber at the point where the light beam exits the coreless fiber is larger than a diameter of the light beam.

5. The device of claim 2, wherein the coreless fiber is terminated with a radius of curvature.

6. The device of claim 5, wherein a thickness and the radius of curvature of the coreless fiber are selected such that the coreless fiber focuses the light beam into a spot.

7. The device of claim 5, wherein the radius of curvature ranges from approximately 25 μm to 60 μm.

8. The device of claim 5, wherein the radius of curvature is greater than 60 μm.

9. The device of claim 2, wherein a terminated end of the coreless fiber is cleaved at an angle.

10. The device of claim 1, wherein a terminated end of the terminated fiber is cleaved at an angle.

11. The device of claim 1, wherein the terminated fiber comprises a ball formed at an end of an optical fiber.

12. The device of claim 11, wherein an optical axis of the ball is offset from an optical axis of the optical fiber.

13. The device of claim 1, wherein the dissipating element is spaced a distance from the terminated fiber to minimize straying of light from the device.

14. The device of claim 1, wherein the terminated fiber has a back-reflection loss better than −50 dB.

15. The device of claim 1, wherein a terminated end of the terminated fiber is disposed in a cavity in a ferrule made of a material having low absorption at a wavelength to be transmitted through the fiber.

16. The device of claim 1, wherein the dissipating element is made of a metallic material.

17. The device of claim 1, wherein the dissipating element is made of a material having thermal conductivity greater than 0.1 W/m. ° C.

18. An optical component, comprising:
a dissipation port; and
an optical power beam dump coupled to the dissipation port, the optical power beam dump comprising a terminated fiber which receives a light beam from the dissipation port and a dissipating element which absorbs the light beam from the terminated fiber, converts the absorbed light beam into thermal energy, and dissipates the thermal energy.

19. The optical component of claim 18, wherein the terminated fiber comprises a coreless fiber attached to a terminated end of an optical fiber, the coreless fiber being arranged in an opposing relation to the dissipating element.

20. The optical component of claim 19, wherein a diameter of the coreless fiber is larger than a diameter of the optical fiber.

21. The optical component of claim 19, wherein a diameter of the coreless fiber at the point where the light beam exits the coreless fiber is larger than a diameter of the light beam.

22. The optical component of claim 19, wherein the coreless fiber is terminated with a radius of curvature.

23. The optical component of claim 19, wherein a terminated end of the coreless fiber is cleaved at an angle.

24. The optical component of claim 18, wherein a terminated end of the terminated fiber is cleaved at an angle.

25. The optical component of claim 18, wherein the terminated fiber comprises a ball formed at an end of an optical fiber.

26. The optical component of claim 18, wherein the dissipating element is spaced a distance from the terminated fiber.

27. The optical component of claim 18, wherein a terminated end of the terminated fiber is disposed in a cavity in a ferrule made of a material having a low absorption at a wavelength to be transmitted through the lensed fiber.

28. An optical component having a functional element, comprising:
a terminated fiber coupled to the functional element to receive a light beam from the functional element; and
an energy dissipating element which encloses the functional element and absorbs the light beam from the terminated fiber, converts the light beam into thermal energy, and dissipates the thermal energy.

29. The optical component of claim 28, wherein the terminated fiber comprises a coreless fiber attached to a terminated end of an optical fiber.

30. The optical component of claim 29, wherein the coreless fiber is terminated with a radius of curvature.

31. The optical component of claim 28, wherein a terminated end of the terminated fiber is cleaved at an angle.

32. The optical component of claim 28, wherein the terminated fiber comprises a ball formed at an end of an optical fiber.

33. The optical component of claim 28, wherein the dissipating element is spaced a distance from the terminated fiber.

34. A method for dissipating thermal energy from an optical component having a functional element, comprising:
diverting a light beam from the functional element to a terminated fiber;
absorbing the light beam from the terminated fiber;
converting the light beam into thermal energy; and
dissipating the thermal energy at a location remote from the functional element.

35. The method of claim 34, wherein dissipating the thermal energy at a location remote from the functional element comprises dissipating the thermal energy at a location remote from the optical component.

36. The method of claim 34, wherein absorbing the light beam from the terminated fiber comprises the terminated fiber focusing the light beam on an energy dissipating element which absorbs the light beam.
